(19) United States
(12) Patent Application Publication
(10) Pub. No.: US 2025/0388778 A1
(43) Pub. Date: Dec. 25, 2025

(54) POLYISOCYANATE MIXTURE

(71) Applicant: Covestro Deutschland AG, Leverkusen (DE)

(72) Inventors: Michael Ludewig, Odenthal (DE); Holger Mundstock, Wermelskirchen (DE)

(21) Appl. No.: 18/880,605

(22) PCT Filed: Jun. 29, 2023
(86) PCT No.: PCT/EP2023/067775

§ 371 Date: Jan. 2, 2025

(30) Foreign Application Priority Data
Jul. 4, 2022 (EP) 22182811.4

(51) Int. Cl. C09D 175/06; C08G 18/42; C08G 18/79

(52) U.S. Cl. CPC C09D 175/06; C08G 18/42; C08G 18/792

(57) ABSTRACT

The present invention relates to a polyisocyanate mixture containing at least one polyisocyanurate polyisocyanate and at least one polyallophanate polyisocyanate, wherein the polyisocyanate mixture has an amount of monomer diisocyanate of <0.10 wt. %, determined in accordance with DIN EN ISO 10283:2007-11 by gas chromatography using an internal standard, an isocyanurate group portion of ≥40 mol % to ≤85 mol %, determined by NMR spectroscopic analysis and based on the total amount of isocyanurate groups and allophanate groups of the polyisocyanate mixture, and an allophanate group portion of ≥15 mol % to ≤60 mol %, determined by NMR spectroscopic analysis and based on the total amount of isocyanurate groups and allophanate groups of the polyisocyanurate mixture.

The present invention relates to a polyisocyanate mixture and to the use thereof. The invention further provides a coating composition containing the polyisocyanate mixture, a process for producing a coating on a substrate, the coating obtainable by this process and the coated substrate.

High-quality lightfast paints particularly employ coatings composed of aliphatic polyisocyanates and polyols, such as for example polyacrylate polyols, polyester polyols or polycarbonate polyols. Polyisocyanates employed for these high-quality coatings particularly include derivatives produced from hexamethylene 1,6-diisocyanate (HDI).

Especially with increasing demands on the stability of a coating system for example in terms of weather resistance and chemicals resistance coupled with a high abrasion resistance, gloss retention and lightfastness, systems having a rather high OH content are necessary on the part of the binder. Due to their chemical composition such systems have an increased polarity compared to standard binders.

EP 0 277 353 A1 describes polyisocyanates having a biuret structure which are said to have good compatibility. However, the monomer stability of biuret-containing polyisocyanates may be reduced.

In these applications too it is preferable to employ polyisocyanurates as crosslinking agents since, due to their low viscosity, they allow formulation of high-solids, VOC-compliant (volatile organic compound-compliant) paint systems. Such polyisocyanurates are described in DE-A2 839 133. However, compared to biuret-containing polyisocyanates, these often exhibit a lower compatibility in the coating system.

As an alternative to pure polyisocyanurates, WO 2019/061019 A1 describes high allophanate-containing polyisocyanate crosslinkers which are produced through the presence of alcohols during catalytic trimerization. However, these have the disadvantage of a high viscosity.

There therefore remained a need to provide a polyisocyanate mixture which exhibits high chemicals resistance coupled with a long pot life, good incorporation characteristics and a good appearance of the obtained coatings.

It was accordingly an object of the present invention to provide a polyisocyanate mixture which exhibits high chemicals resistance coupled with a long pot life, good incorporation characteristics and good appearance of the obtained coatings.

This object is achieved according to the invention by a polyisocyanate mixture containing at least one polyisocyanurate-polyisocyanate and at least one polyallophanate-polyisocyanate, wherein the polyisocyanate mixture has a content of monomeric diisocyanates of <0.10% by weight determined by gas chromatography with an internal standard according to DIN EN ISO 10283:2007-11, an isocyanurate group content of ≥40 mol % to ≤85 mol % determined by NMR spectroscopic analysis and based on the total amount of isocyanurate groups and allophanate groups of the polyisocyanate mixture and
an allophanate group content of ≥15 mol % to ≤60 mol % determined by NMR spectroscopic analysis and based on the total amount of isocyanurate groups and allophanate groups of the polyisocyanate mixture.

According to the invention the terms “comprising” or “containing” are preferably to be understood as meaning “substantially consisting of” and particularly preferably “consisting of”. The further embodiments recited in the claims and in the description may be combined as desired, provided that the context does not clearly indicate the opposite.

The polyisocyanate mixture according to the invention is a physical mixture and thus differs from a purely chemically produced polyisocyanate in terms of its oligomer distribution for example, since the polyisocyanate mixture according to the invention does not have a random distribution of the allophanate and isocyanurate groups over the entirety of polyisocyanate oligomers.

The at least one polyisocyanurate-polyisocyanate may contain other structural units—only in subordinate amounts if at all—such as for example uretdione structures but also allophanate structures, wherein isocyanurate structures in any case account for the majority, preferably more than 80 mol % and particularly preferably more than 90 mol %, determined by NMR spectroscopic analysis and based on the total amount of isocyanurate groups, of allophanate groups and optionally further oligomerization structures of the polyisocyanurate-polyisocyanate. Also employable as polyisocyanurate-polyisocyanates according to the invention are isocyanurate-iminooxadiazinedione polyisocyanates having a proportion of 5 to 20 mol % of iminooxadiazinedione structures (also known as asymmetric trimers) and an isocyanurate fraction of at least 50 mol % determined by NMR spectroscopic analysis and based on the total amount of isocyanurate groups, iminooxadiazinedione groups, allophanate groups and optionally further oligomerization structures of the polyisocyanurate-polyisocyanate. Such isocyanurate-iminooxadiazinedione polyisocyanates are in the present case also referred to as polyisocyanurate-polyisocyanates.

The at least one polyallophanate-polyisocyanate may also contain—only in subordinate amounts if at all—other structural units, such as uretdione structures, iminoxadiazinedione structures (so-called asymmetric trimers) but also isocyanurate structures, wherein the allophanate structures in any case account for the majority. However, according to the invention it is also possible to employ mixed allophanate-isocyanurate products having an allophanate fraction of at least 50 mol % determined by NMR spectroscopic analysis and based on the total amount of isocyanurate groups, iminooxadiazinedione groups, allophanate groups and optionally further oligomerization structures of the polyallophanate-polyisocyanate. Such mixed allophanate-isocyanurate products are in the present case also referred to as polyallophanate-polyisocyanates.

The contents (mol-%) of the isocyanurate and allophanate structures present in the polyisocyanate mixture according to the invention or in the individual polyisocyanates used for the mixture are preferably calculated from the integral proton-decoupled ¹³C-NMR spectra and are in each case based on the sum of isocyanurate and allophanate structures present. This was done using a Bruker AV III HD 600 NMR spectrometer with a Z150361 001 (CP BBO 600SS3 BB-H&F-05 ZE T) sample head at 512 scans. At a repetition time (D1) of 4 s and a measurement time (AQ) of 1.57 s it is assumed according to the invention that very similar carbonyl carbon atoms are comparable by integration. In the case of hexamethylene diisocyanate-based polyisocyanates dissolved in CDCl₃, the individual structural elements have the following chemical shifts (in ppm): isocyanurate: 148.4; iminooxadiazinedione: 147.8, 144.3 and 135.3; allophanate: 155.7 and 153.8. Chemical shifts (in ppm) of structural elements possibly present in subordinate amounts in the case of hexamethylene diisocyanate-based polyisocyanates dissolved in CDCl₃ are as follows: uretdione: 157.1; biuret: 155.5; urethane: 156.3; oxadiazinetrione: 147.8 and 143.9; uretonimine: 158.7 and 144.6.

The weight-average molecular weight of both the polyisocyanate mixture and the individual polyisocyanates used for the mixture is in the context of the present invention determined by gel permeation chromatography according to DIN EN ISO 13885-1:2021-11 using a polystyrene standard.

The content of monomeric diisocyanates is determined according to DIN EN ISO 10283:2007-11 by gas chromatography using an internal standard.

In the context of the invention the pot life is defined as the time taken for the viscosity of the coating composition to double (determined indirectly via doubling of the flow time in a DIN cup, 4 mm).

An “organic compound” or “organic radical” contains at least one unit comprising a covalent carbon-hydrogen bond.

The term “aliphatic” is presently defined as meaning non-aromatic hydrocarbon groups that are saturated or unsaturated.

The term “araliphatic” is presently defined as meaning hydrocarbon radicals consisting of both an aromatic hydrocarbon group and a saturated or unsaturated hydrocarbon group which is bonded directly to the aromatic radical.

The term “alicyclic” or “cycloaliphatic” is presently defined as meaning optionally substituted carbocyclic or heterocyclic compounds or units which are not aromatic.

“At least one”, as used herein, refers to 1 or more, for example 2, 3, 4, 5, 6, 7, 8, 9 or more. In connection with constituents of the compounds described herein, this figure refers not to the absolute number of molecules, but rather to the nature of the constituent. “At least one polyallophanate-polyisocyanate” is therefore to be understood as meaning for example that only one type of compound or two or more different types of compounds of this type may be present without specifying the amount of the individual compounds.

Numerical ranges given in the format “in/from x to y” include the values stated. If two or more preferred numerical ranges are given in this format, it is understood that all ranges arising from the combination of the various limits are likewise encompassed.

In a first preferred embodiment the polyisocyanate mixture according to the invention has an isocyanurate group content of ≥45 mol % to ≤80 mol %, preferably ≥50 mol % to ≤75 mol % and particularly preferably ≥53 mol % to ≤72 mol % determined by NMR spectroscopic analysis and based on the total amount of isocyanurate groups and allophanate groups of the polyisocyanate mixture and/or an allophanate group content of ≥20 mol % to ≤55 mol %, preferably ≥25 mol % to ≤50 mol % and particularly preferably ≥28 mol % to ≤47 mol % determined by NMR spectroscopic analysis and based on the total amount of isocyanurate groups and allophanate groups of the polyisocyanate mixture. This results in the advantage of a further extended pot life coupled with at least unchanged good compatibility in the paint system.

In a further preferred embodiment the polyisocyanate mixture according to the invention has a weight-average molecular weight of ≥1000 g/mol to ≤3000 g/mol, preferably of ≥1300 g/mol to ≤2700 g/mol and particularly preferably of ≥1500 g/mol to ≤2500 g/mol determined according to EN ISO 13885-1:2021-11. This results in the further advantage of achieving a further improved pot life coupled with good chemicals resistance.

In a further preferred embodiment the polyisocyanate mixture according to the invention has a polydispersity of ≥1.5 to ≤2.5, preferably of ≥1.7 to ≤2.2, determined according to DIN 55672-1:2016-03. This also results in the further advantage that good chemicals resistance is coupled with a further improved pot life which may be still further enhanced in conjunction with the two aforementioned preferred embodiments.

Suitable starting compounds for producing polyisocyanurate-polyisocyanates and polyallophanate-polyisocyanates suitable for producing the polyisocyanate mixture according to the invention include any desired monomeric diisocyanates having aliphatically, cycloaliphatically, araliphatically and/or aromatically bonded isocyanate groups which are producible by any desired processes, for example by phosgenation or by a phosgene-free route, for example by urethane cleavage.

Suitable monomeric diisocyanates, hereinbelow also referred to as starting diisocyanates, include for example those in the molecular weight range 168 to 400 g/mol, for example 1,6-diisocyanatohexane (HDI), 1,5-diisocyanato-2,2-dimethylpentane, 2,2,4- or 2,4,4-trimethyl-1,6-diisocyanatohexane, 1,8-diisocyanatooctane, 1,9-diisocyanatononane, 1,10-diiisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (XDI), 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate and any desired mixtures of these isomers, diphenylmethane 2,4′- and/or 4,4′-diisocyanate and naphthylene 1,5-diisocyanate and any desired mixtures of such diisocyanates. Further diisocyanates that are likewise suitable may additionally be found for example in Justus Liebigs Annalen der Chemie, 562, 1949, 75-136.

Particularly preferred starting diisocyanates include linear or branched, aliphatic or cycloaliphatic diisocyanates of the aforementioned type. Very particularly preferred starting diisocyanates include 1,6-diisocyanatohexane, 1-isocyanato-3,3,5-trimethyl-5-isocyanatomethylcyclohexane, 2,4′- and/or 4,4′-diisocyanatodicyclohexylmethane, 1,3- and 1,4-bis-(isocyanatomethyl)benzene or any mixtures of these diisocyanates. 1,6-Diisocyanatohexane (HDI) is especially preferred.

The starting diisocyanates may be converted into polyisocyanurate-polyisocyanates and/or into polyallophanate-polyisocyanates by various modification processes known per se. These polyisocyanurate-polyisocyanates and polyallophanate-polyisocyanates are mixed so as to obtain the polyisocyanate mixture according to the invention, It is possible to employ any desired mixing ratios and a person skilled in the art can select these without any great inconvenience by reference to the individual polyisocyanate specifications such as for example molar content of isocyanurate or allophanate groups by NMR spectroscopic analysis or, if preferred, determination of the weight-average molecular weight according to the aforementioned DIN EN ISO 13885-1:2021-11 using a polystyrene standard.

In a further preferred embodiment the at least one polyisocyanurate-polyisocyanate comprises one or more isocyanurate groups which are each chemically bonded to one another via an aliphatic, cycloaliphatic or araliphatic group having a molecular weight of ≥56 to ≤316 g/mol, preferably each chemically bonded to one another via a 1,4-butyl or 1,6-hexyl group and particularly preferably chemically bonded to one another via a 1,6-hexyl group.

In the present case a 1,4-butyl or 1,6-hexyl group is to be understood as meaning that positions 1 and 4 or 1 and 6 respectively are each missing a hydrogen atom and the group is chemically bonded via these atoms. The “1,4-butyl or 1,6-hexyl group” may in the present case also be referred to as “1,4-butanediyl” or “1,6-hexanediyl group”.

A preferred modification reaction for producing polyisocyanurate-polyisocyanates for the polyisocyanate mixture according to the invention is for example the catalytic trimerization of starting diisocyanates. Such catalysts may in principle be selected from any compounds that accelerate the trimerization of isocyanate groups into isocyanurate structures.

Suitable catalysts for producing polyisocyanurate-polyisocyanates are for example simple tertiary amines, such as for example triethylamine, tributylamine, N,N-dimethylaniline, N-ethylpiperidine, N, N′-dimethylpiperazine, or teriary phosphines, such as for example triethylphosphine, tributylphosphine or dimethylphenylphosphine. Suitable catalysts also include the tertiary hydroxyalkylamines described in GB 2 221 465, for example triethanolamine, N-methyldiethanolamine, dimethylethanolamine, N-isopropyldiethanolamine and 1-(2-hydroxyethyl)pyrrolidine, or the catalyst systems that are known from GB 2 222 161 and consist of mixtures of tertiary bicyclic amines, for example DBU, with simple low molecular weight aliphatic alcohols.

A multiplicity of different metal compounds are likewise suitable as trimerization catalysts. Suitable examples are the octoates and naphthenates of manganese, iron, cobalt, nickel, copper, zinc, zirconium, cerium or lead or mixtures thereof with acetates of lithium, sodium, potassium, calcium or barium that are described as catalysts in DE-A 3 240 613, the sodium and potassium salts of linear or branched alkanecarboxylic acids having up to 10 carbon atoms that are disclosed by DE-A 3 219 608, such as of propionic acid, butyric acid, valeric acid, caproic acid, heptanoic acid, caprylic acid, pelargonic acid, capric acid and undecyl acid, the alkali metal or alkaline earth metal salts of aliphatic, cycloaliphatic or aromatic mono- and polycarboxylic acids having 2 to 20 carbon atoms that are disclosed by EP-A 0 100 129, such as sodium benzoate or potassium benzoate, the alkali metal phenoxides disclosed by GB 1 391 066 A and GB 1 386 399 A, such as sodium phenoxide or potassium phenoxide, the alkali metal and alkaline earth metal oxides, hydroxides, carbonates, alkoxides and phenoxides disclosed by GB 809 809, alkali metal salts of enolizable compounds and metal salts of weak aliphatic or cycloaliphatic carboxylic acids such as sodium methoxide, sodium acetate, potassium acetate, sodium acetoacetate, lead 2-ethylhexanoate, and lead naphthenate, the basic alkali metal compounds complexed with crown ethers or polyether alcohols that are disclosed by EP-A 0 056 158 and EP-A 0 056 159, such as complexed sodium carboxylates or potassium carboxylates, the pyrrolidinone potassium salt disclosed by EP-A 0 033 581, the mono- or polynuclear complex compounds of titanium, zirconium and/or hafnium known from EP-A 2 883 895, for example zirconium tetra-n-butoxide, zirconium tetra-2-ethylhexanoate and zirconium tetra-2-ethylhexoxide, and tin compounds of the type described in European Polymer Journal, 16, 1979, 147-148, for example dibutyltin dichloride, diphenyltin dichloride, triphenylstannanol, tributyltin acetate, tributyltin oxide, tin dioctoate, dibutyl(dimethoxy)stannane, and tributyltin imidazolate.

Further trimerization catalysts suitable for producing polyisocyanurate-polyisocyanates are, for example, the quaternary ammonium hydroxides known from DE-A 1 667 309, EP-A 0 013 880 and EP-A 0 047 452, for example tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2]octane hydroxide (monoadduct of ethylene oxide and water onto 1,4-diazabicyclo[2.2.2]octane), the quaternary hydroxyalkylammonium hydroxides known from EP-A 37 65 or EP-A 10 589, for example N,N,N-trimethyl-N-(2-hydroxyethyl)ammonium hydroxide, the trialkylhydroxylalkylammonium carboxylates that are known from DE-A 2631733, EP-A 0 671 426, EP-A 1 599 526 and U.S. Pat. No. 4,789,705, for example N,N,N-trimethyl-N-2-hydroxypropylammonium p-tert-butylbenzoate and N,N,N-trimethyl-N-2-hydroxypropylammonium 2-ethylhexanoate, the quaternary benzylammonium carboxylates known from EP-A 1 229 016, for example N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium 2-ethylhexanoate or N,N,N-tributyl-N-(4-methoxybenzyl)ammonium pivalate, the tetrasubstituted ammonium α-hydroxycarboxylates known from WO 2005/087828, for example tetramethylammonium lactate, the quaternary ammonium or phosphonium fluorides known from EP-A 0 339 396, EP-A 0 379 914 and EP-A 0 443 167, for example N-methyl-N,N,N-trialkylammonium fluorides with C₈-C₁₀-alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride, the quaternary ammonium and phosphonium polyfluorides known from EP-A 0 798 299, EP-A 0 896 009 and EP-A 0 962 455, for example benzyltrimethylammonium hydrogen polyfluoride, the tetraalkylammonium alkylcarbonates which are known from EP-A 0 668 271 and are obtainable by reaction of tertiary amines with dialkyl carbonates, or betaine-structured quaternary ammonioalkyl carbonates, the quaternary ammonium hydrogencarbonates known from WO 1999/023128, for example choline bicarbonate, the quaternary ammonium salts which are known from EP 0 102 482 and are obtainable from tertiary amines and alkylating esters of phosphorus acids, examples of such salts being reaction products of triethylamine, DABCO or N-methylmorpholine with dimethyl methanephosphonate, or the tetrasubstituted ammonium salts of lactams that are known from WO 2013/167404, for example trioctylammonium caprolactamate or dodecyltrimethylammonium caprolactamate.

These catalysts may be used either individually or in the form of any mixtures with one another. Preferred catalysts are ammonium and phosphonium salts of the aforementioned type, in particular trialkyl hydroxylalkylammonium carboxylates, benzylammonium carboxylates, quaternary ammonium hydroxides, hydroxyalkylammonium hydroxides, ammonium or phosphonium fluorides and ammonium and phosphonium polyfluorides of the recited type. Particularly preferred trimerization catalysts are quaternary ammonium hydroxides as well as ammonium and phosphonium polyfluorides of the recited type.

In the production of polyisocyanurate-polyisocyanates for the polyisocyanate mixture according to the invention the trimerization catalyst is generally employed in a concentration based on the amount of the employed starting diisocyanates of 0.0005% to 5.0% by weight, preferably of 0.0010% to 2.0% by weight and particularly preferably of 0.0015% to 1.0% by weight.

The trimerization catalysts are preferably added to the starting diisocyanates in neat form. However, to improve their compatibility the recited trimerization catalysts may optionally also be employed dissolved in a suitable organic solvent. The degree of dilution of the catalyst solutions is freely choosable within a very wide range. Catalyst solutions of this kind are typically catalytically active above a concentration of about 0.01% by weight.

Suitable catalyst solvents are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl ether acetate, ethylene glycol monoethyl ether acetate, diethylene glycol ethyl ether acetate, diethylene glycol butyl ether acetate, propylene glycol monomethyl ether acetate, 1-methoxyprop-2-yl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

If the production of suitable polyisocyanurate-polyisocyanates employs catalyst solvents it is preferable to employ catalyst solvents which bear groups reactive toward isocyanates and can be incorporated into the polyisocyanurate-polyisocyanate. Examples of such solvents include mono- or polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethylallyl alcohol or oleyl alcohol; araliphatic alcohols, for example benzyl alcohol; N-monosubstituted amides, for example N-methylformamide, N-methylacetamide, cyanoacetamide or 2-pyrrolidinone, or any desired mixtures of such solvents. In the case of optional co-use of such catalyst solvents bearing groups reactive toward isocyanates, any allophanate groups thus formed are counted with the inventive molar proportion of allophanate groups and with the total amount of isocyanurate and allophanate groups in the polyisocyanate mixture according to the invention.

According to the invention the polyisocyanurate-polyisocyanates employed may also include isocyanurate-iminooxadiazinedione-polyisocyanates containing an isocyanurate proportion of at least 50 mol %—in the context of the present invention these are also referred to as polyisocyanurate-polyisocyanates. Such iminooxadiazidione groups (also known as asymmetric trimers) may be produced for example by processes described in EP-A 0 798 299, EP-A 0 962 454, WO2015/124504 or WO 2017/029266.

The production of polyisocyanurate-polyisocyanates for the polyisocyanate mixture according to the invention is carried out by processes known per se, such as are described for example in the publications recited above in connection with the list of suitable trimerization catalysts.

The starting diisocyanates, optionally under inert gas, for example nitrogen, and optionally in the presence of solvent, for example of the kind such as are recited hereinabove as possible catalyst solvents inert toward isocyanate groups, are generally admixed with a suitable trimerization catalyst in the aforementioned amount at a temperature between 0° C. at 150° C., preferably 20° C. to 130° C., particularly preferably 40° C. to 120° C., thus leading to commencement of the trimerization reaction to form isocyanurate structures.

As in all production processes of polyisocyanates the progress of the reaction may be monitored for the use according to the invention by titrimetric determination of the NCO content according to DIN EN ISO 11909:2007-05 for example.

After achieving the desired degree of oligomerization the trimerization reaction is terminated, wherein the “degree of oligomerization” is to be understood as meaning the percentage of isocyanate groups originally present in the reaction mixture that is consumed during the production process preferably to form isocyanurate structures. The minimum degree of oligomerization to be targeted may be varied according to the type of the employed starting diisocyanate or mixture of starting diisocyanates.

Reaction termination at the desired degree of oligomerization may be effected for example by cooling the reaction mixture to room temperature. However, it is generally the case that the reaction is terminated by adding a catalyst poison optionally followed by a brief heating of the reaction mixture to a temperature above 80° C. for example.

Such catalyst poisons include for example inorganic acids such as hydrochloric acid, phosphorous acid or phosphoric acid, acid chlorides such as acetyl chloride, benzoyl chloride or isophthaloyl dichloride, sulfonic acids and sulfonic esters, such as methanesulfonic acid, p-toluenesulfonic acid, trifluoromethanesulfonic acid, perfluorobutanesulfonic acid, dodecylbenzenesulfonic acid, methyl and ethyl p-toluenesulfonate, mono- and dialkyl phosphates such as monotridecyl phosphate, dibutyl phosphate and dioctyl phosphate, but also silylated acids such as trimethylsilyl methanesulfonate, trimethylsilyl trifluoromethanesulfonate, tris(trimethylsilyl) phosphate and diethyl trimethylsilyl phosphate.

The amount of catalyst poison required to terminate the reaction depends on the amount of employed trimerization catalyst; generally one equivalent of catalyst poison is employed based on initially employed catalyst. However, if any losses of catalyst occurring during the reaction are taken into account termination of the reaction may already be achieved with 20 to 80 equivalent % of catalyst poison based on the amount of originally employed catalyst.

The aforementioned catalyst poisons may be employed either neat or dissolved in a suitable solvent. Suitable solvents include for example the solvents already described above as possible catalyst solvents or mixtures thereof. The degree of dilution is freely choosable within a very wide range and solutions having a concentration of 1% by weight or more are suitable for example.

In addition to the aforementioned solvents it is also possible to employ the aforementioned starting diisocyanates as solvents for the catalyst poisons provided the latter are sufficiently inert toward isocyanate groups to allow production of storage-stable solutions.

After completion of reaction the reaction mixture is preferably freed of volatile constituents (for example excess starting diisocyanates and optionally co-used solvents) by thin-film distillation under vacuum, for example at a pressure of below 1.0 mbar, preferably below 0.5 mbar, particularly preferably below 0.2 mbar, under very gentle conditions, for example at a temperature of 100° C. to 200° C., preferably of 120° C. to 180° C.

It is likewise possible to remove the recited volatile constituents from the polyisocyanate by extraction with suitable solvents inert toward isocyanate groups, for example aliphatic or cycloaliphatic hydrocarbons such as pentane, hexane, heptane, cyclopentane or cyclohexane.

The residual content of monomeric diisocyanate after the distillation/extraction is preferably ≤0.50% by weight, particularly preferably ≤0.3% by weight and particularly preferably ≤0.10% by weight. The proportion of monomeric diisocyanate in the at least one polyisocyanurate-polyisocyanate may be greater than 0.10% by weight provided it is less than 0.10% by weight in the polyisocyanate mixture according to the invention.

In addition to the at least one polyisocyanurate-polyisocyanate the polyisocyanate mixture according to the invention also contains at least one polyallophanate-polyisocyanate obtained for example by reaction of the recited starting diisocyanates with hydroxy-functional compounds.

In a further preferred embodiment the at least one polyallophanate-polyisocyanate comprises one or more allophanate groups which are each chemically bonded to one another via an aliphatic, cycloaliphatic or araliphatic group having a molecular weight of ≥56 to ≤316 g/mol, preferably each chemically bonded to one another via a 1,4-butyl or 1,6-hexyl group and particularly preferably each chemically bonded to one another via a 1,6-hexyl group.

In the present case a 1,4-butyl or 1,6-hexyl group is to be understood as meaning that positions 1 and 4 or 1 and 6 respectively are each missing a hydrogen atom and the group is chemically bonded via these atoms. The “1,4-butyl or 1,6-hexyl group” may in the present case also be referred to as “1,4-butanediyl” or “1,6-hexanediyl group”.

In the event that mixtures of different starting diisocyanates are employed it is very particularly preferable when ≤30% by weight, preferably ≤10% by weight and particularly preferably ≥0% to ≤5% by weight of the altogether employed starting diisocyanates are cycloaliphatic diisocyanates and the remainder are aliphatic diisocyanates.

Suitable hydroxyfunctional compounds for producing the polyallophanate-polyisocyanates for the polyisocyanate mixture according to the invention include for example any monohydric or polyhydric alcohols having up to 14 carbon atoms, preferably 2 to 6 carbon atoms, such as for example the monohydric or polyhydric alcohols recited hereinabove as suitable hydroxy-functional catalyst solvents and tetrahydrofurfuryl alcohol, the isomeric pentanediols, hexanediols, heptanediols and octanediols, 1,10-decanediol, 1,2- and 1,4-cyclohexanediol, 1,4-cyclohexanedimethanol, 4.4′-(1-methylethylidene)biscyclohexanol, 1,1,1-trimethylolethane, 1,2,6-hexanetriol, 1,1,1-trimethylolpropane, 2,2-bis(hydroxymethyl)-1,3-propanediol, bis(2-hydroxyethyl)hydroquinone, 1,2,4- and 1,3,5-trihydroxycyclohexane or 1,3,5-tris(2-hydroxyethyl)isocyanurate but also simple ester alcohols, such as for example neopentyl glycol hydroxypivalate.

Suitable hydroxyfunctional compounds for producing the polyallophanate-polyisocyanates also include the higher molecular weight polyhydroxyl compounds of the polyester, polycarbonate, polyester carbonate or polyether type known per se, in particular those in the molecular weight range 200 to 2000 g/mol.

Polyester polyols suitable as hydroxy-functional compounds include for example those having an average molecular weight calculable from functionality and hydroxyl number of 200 g/mol to 4000 g/mol, preferably of 250 g/mol to 2500 g/mol, having a hydroxyl group content of 1% to 21% by weight, preferably 2% to 18% by weight, such as are producible in a manner known per se by reacting polyhydric alcohols, for example those mentioned above having 2 to 14 carbon atoms, with deficit amounts of polybasic carboxylic acids, corresponding carboxylic anhydrides, corresponding polycarboxylic esters of lower alcohols, or lactones.

The acids or acid derivatives used for producing the polyester polyols may be aliphatic, cycloaliphatic and/or aromatic in nature and may optionally be substituted, for example by halogen atoms, and/or unsaturated. Examples of suitable acids include for example polybasic carboxylic acids in the molecular weight range 118 to 300 g/mol or derivatives thereof such as for example succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, dimethyl terephthalate and bisglycol terephthalate.

Production of the polyester polyols may also employ any desired mixtures of these starting compounds recited by way of example.

A type of polyester polyols alternatively employable as the hydroxy-functional compound is selected from those producible by ring opening in a manner known per se from lactones and simple polyhydric alcohols, for example those mentioned by way of example hereinabove, as starter molecules. Examples of suitable lactones for producing these polyester polyols are for example β-propiolactone, γ-butyrolactone, δ- and δ-valerolactone, ε-caprolactone, 3,5,5- and 3,3,5-trimethylcaprolactone or any desired mixtures of such lactones.

Polyhydroxyl compounds of the polycarbonate type which are suitable as hydroxy-functional compounds especially include the polycarbonate diols known per se such as are obtainable for example by reaction of dihydric alcohols, for example those recited by way of example in the above list of polyhydric alcohols in the molecular weight range 62 to 400 g/mol, with diaryl carbonates, such as for example diphenyl carbonate, dialkyl carbonates, such as for example dimethyl carbonate, or phosgene.

Suitable polyhydroxyl compounds of the polyester carbonate type which are suitable as hydroxy-functional compounds include in particular the ester- and carbonate-comprising diols that are known per se, such as are obtainable for example according to the teaching of DE-A 1 770 245 or WO 03/002630 by reacting dihydric alcohols with lactones of the type recited by way of example above, in particular ε-caprolactone and subsequent reaction of the resulting polyester diols with diphenyl carbonate or dimethyl carbonate.

Polyether polyols suitable as hydroxy-functional compounds include in particular those having an average molecular weight, calculable from functionality and hydroxyl number, of 200 to 2000 g/mol, preferably 250 to 1000 g/mol, having a hydroxyl group content of 1.6% to 25% by weight, preferably 3.6% to 20% by weight, such as are obtainable in a manner known per se by alkoxylation of suitable starter molecules. To produce these polyether polyols any desired polyhydric alcohols, such as the above-described simple polyhydric alcohols having 2 to 14 carbon atoms, may be employed as starter molecules. Suitable alkylene oxides for the alkoxylation reaction especially include ethylene oxide and propylene oxide which may be employed in the alkoxylation reaction in any sequence or else in admixture.

Suitable polyether polyols also include the polyoxytetramethylene glycols known per se, such as are obtainable for example by polymerization of tetrahydrofuran according to H. Meerwein et al., Angew. Chem. 72, 1960, 927-934. However, the use of polyether polyols is not preferred.

Preferred hydroxyfunctional compounds are the aforementioned simple polyhydric alcohols, or ester or ether alcohols in the molecular weight range 62 to 400 g/mol. Particular preference is given to the diols and/or triols having 2 to 6 carbon atoms recited above within the list of simple polyhydric alcohols. Particularly preferred hydroxyfunctional compounds are ethane-1,2-diol, propane-1,2-diol, propane-1,3-diol, butane-1,3-diol, butane-1,4-diol, hexane-1,6-diol, and/or 1,1,1-trimethylolpropane. The use of 1,1,1-trimethylpropane is especially preferred.

In a further preferred embodiment the polyallophanate-polyisocyanate is obtained by oligomerization of at least one aliphatic, cycloaliphatic or araliphatic monomeric diisocyanate having a molecular weight of ≥140 to ≤400 g/mol and at least one hydroxy-functional compound having an OH functionality of ≥2 and ≤6 in the presence of a catalyst.

It is preferable when the hydroxy-functional compound has an OH functionality of ≥3 and ≤5 and/or a molecular weight of ≥85 to ≤2000 g/mol, particularly preferably an OH functionality of ≥3 and ≤4 and/or a molecular weight of ≥130 to ≤500 g/mol. It is also possible to use mixtures of such alcohols.

The at least one polyallophanate-polyisocyanate is alternatively preferably obtainable by oligomerization of at least one aliphatic, cycloaliphatic or araliphatic monomeric diisocyanate having a molecular weight of ≥140 to ≤400 g/mol and at least one hydroxy-functional compound having an OH functionality of ≥3 and ≤6. It is also possible to use mixtures of such alcohols.

The at least one polyallophanate-polyisocyanate is preferably obtained by oligomerization of at least one aliphatic diisocyanate having a molecular weight of ≥140 to ≤400 g/mol, preferably of 1,6-diisocyanatohexane (HDI), and at least one hydroxy-functional compound having an OH functionality of ≥3 and ≤5 and/or a molecular weight of ≥85 to ≤2000 g/mol, preferably an OH functionality of ≥3 and ≤4 and/or a molecular weight of ≥130 to ≤500 g/mol. It is also possible to use mixtures of such alcohols.

The starting diisocyanates and hydroxy-functional compounds are preferably reacted in an equivalent ratio of isocyanate groups to hydroxyl groups of 4:1 to 200:1, preferably of 5:1 to 50:1 and particularly preferably 5:1 to 25:1, in the presence of at least one suitable catalyst of the recited type.

The reaction to produce the polyallophanate-polyisocyanate may be performed uncatalyzed, as a thermally-induced allophanatization. However, it is preferable to employ suitable catalysts for reaction acceleration. Suitable catalysts for the reaction include for example the catalysts recited in WO 2019/061019 A1 on page 11, line 13 to page 13, line 11. Said catalysts are added either in neat form or dissolved in a suitable organic solvent in order to accelerate the formation of the allophanate groups. Preferred catalyst solvents are those having groups that are reactive toward isocyanates and are correspondingly capable of incorporation into the polymer. These include for example mono- or polyhydric alcohols such as methanol, ethanol, n-propanol, isopropanol, n-butanol, n-hexanol, 2-ethyl-1-hexanol, ethylene glycol, propylene glycol, isomers of butanediol, 2-ethylhexane-1,3-diol, glycerol, ether alcohols such as 1-methoxy-2-propanol, 3-ethyl-3-hydroxymethyloxetane, tetrahydrofurfuryl alcohol, ethylene glycol monomethyl ether, ethylene glycol monobutyl ether, diethylene glycol monomethyl ether, diethylene glycol monoethyl ether, diethylene glycol monobutyl ether, diethylene glycol, dipropylene glycol, polyethylene glycols, polypropylene glycols, mixed polyethylene/polypropylene glycols and the monoalkyl ethers thereof, ester alcohols such as ethylene glycol monoacetate, propylene glycol monolaurate, glycerol diacetate, glycerol monobutyrate or 2,2,4-trimethylpentane-1,3-diol monoisobutyrate, unsaturated alcohols such as allyl alcohol, 1,1-dimethylallyl alcohol or oleyl alcohol, araliphatic alcohols such as benzyl alcohol or monosubstituted amides such as N-methylformamide, N-methylacetamide, cyanoacetamide or 2-pyrrolidinone or mixtures of such solvents.

The reaction is preferably carried out under an inert gas atmosphere at a temperature in the range from 0° C. to 150° C., preferably in the range between 40° C. and 130° C. and particularly preferably between 70° C. and 120° C.

Once the desired conversion rate has been achieved the reaction is stopped. This can be effected, for example, by cooling the reaction mixture. It is preferable when the stopping is effected by addition of a catalyst poison and optionally subsequent heating of the reaction mixture to a temperature above 80° C.

Suitable catalyst poisons (stoppers) are known to those skilled in the art. By way of example, said catalyst poisons are hydrochloric acid, phosphoric acid, phosphonic acid, carbonyl chlorides such as acetyl chloride, benzoyl chloride or isophthaloyl dichloride, sulfonic acids or sulfonic esters, such as methanesulfonic esters, p-toluenesulfonic acid, trifluoromethanesulfonic acid, perfluorobutanesulfonic acid, dodecylbenzenesulfonic acid, methyl p-toluenesulfonate, ethyl p-toluenesulfonate, mono- or dialkyl phosphates such as tridecyl phosphate, dibutyl phosphate, dioctyl phosphate, or silylated acids such as trimethylsilyl methanesulfonate, trimethylsilyl trifluoromethansulfonate, tris(trimethylsilyl) phosphate or diethyl trimethylsilyl phosphate.

The amount of catalyst poison needed to stop the reaction depends essentially on the amount of catalyst used. In principle, an equivalent amount of stopper is required; however, since some of the catalyst is usually deactivated in some other way, a smaller amount of stopper may also be sufficient.

It is also possible to add the catalyst poison as such or in solution, the catalyst solvents listed previously for example being suitable as solvent. In addition to these solvents, the starting isocyanates may also be used as solvent for the catalyst poisons.

Once the reaction has been terminated a separation of the starting diisocyanate from the reaction product is carried out. This is preferably carried out by distillation, for example at a pressure below mbar, preferably below 1 mbar and particularly preferably below 0.5 mbar and for example at a temperature in the range from 100° C. to 200° C., preferably in the range from 120° C. to 180° C. The residual content of monomeric diisocyanate after distillation is preferably ≤0.50% by weight, particularly preferably ≤0.3% by weight and particularly preferably <0.10% by weight. The proportion of monomeric diisocyanate in the at least one polyallophanate-polyisocyanate may be greater than 0.10% provided it is less than 0.10% by weight in the polyisocyanate mixture according to the invention.

It is preferable when the polyallophanate polyisocyanate has an average isocyanate functionality ≥4 and/or a weight-average molecular weight of ≥3000 g/mol determined according to EN ISO 13885-1:2021-11.

In the present case the average isocyanate functionality of the at least one polyisocyanate present in the polyisocyanurate-polyisocyanates is determined by the following formula:

$${F}_{( GPC )} = \frac{{Mn}_{( GPC )}}{\frac{100 \times 42}{\% {NCO}_{( Titr . )}}}$$

wherein the isocyanate content is reported in % by weight and determined titrimetrically according to DIN EN ISO 11909:2007-05 and the number-average molecular weight is determined by GPC according to DIN EN ISO 13885-1:2021-11 using a polystyrene standard and tetrahydrofuran as the eluent.

The present invention further provides a process for producing a polyisocyanate mixture according to the invention, characterized in that at least one polyisocyanurate-polyisocyanate and at least one polyallophanate-polyisocyanate are mixed, wherein the at least one polyisocyanurate-polyisocyanate preferably has a weight-average molecular weight of ≤1000 g/mol determined according to DIN EN ISO 13885-1:2021-11 and/or the at least one polyallophanate-polyisocyanate has a weight-average molecular weight of ≥3000 g/mol determined according to DIN EN ISO 13885-1:2021-11.

The mixing is carried out by any desired methods and in any order. A suitable solvent may be added to the process if desired. Suitable solvents include those generally known to those skilled in the art as solvents in the coatings field and recited by way of example in the present text.

In a preferred embodiment of the process according to the invention 30-70 parts by weight of the at least one polyisocyanurate polyisocyanate and 70-30 parts by weight of the at least one polyallophanate-polyisocyanate are mixed. For the mixing one and/or both polyisocyanates may contain one or more of the solvents recited in the present text, preferably at least butyl acetate. In case of co-use of one or more solvents it is particularly preferable when the polyallophanate-polyisocyanate is present in the solvent.

The present invention further provides for a coating composition containing either at least one polyisocyanate mixture according to the invention and at least one isocyanate-reactive binder or containing at least one polyisocyanate mixture obtainable or produced by a process according to claim 8 or 9 and at least one isocyanate-reactive binder.

In a further preferred embodiment the coating composition according to the invention contains the at least one isocyanate-reactive binder in a component A) and the at least one polyisocyanate mixture according to the invention in a component B) or the at least one polyisocyanate mixture obtainable or produced by a process according to claim 8 or 9 in a component B). Such a preferred embodiment is hereinbelow also referred to as a two-component system.

Employable “isocyanate-reactive binders” include all compounds which are known to those skilled in the art and have an average OH or NH functionality of at least 1.5. These may include for example low molecular weight diols (e.g. ethane-1,2-diol, propane-1,3- or -1,2-diol, butane-1,4-diol), triols (e.g. glycerol, trimethylolpropane) and tetraols (e.g. pentaerythritol), short-chain polyamines, but also polyhydroxyl compounds such as polyether polyols, polyester polyols, polyurethane polyols, polysiloxane polyols, polycarbonate polyols, polyetherpolyamines, polybutadiene polyols, polyacrylate polyols and/or polymethacrylate polyols and copolymers thereof, referred to hereinbelow as polyacrylate polyols.

Irrespective of whether it is the coating composition according to the invention or the preferred two-component system according to the invention that is concerned it is further preferable when the at least one isocyanate-reactive binder is a polyhydroxy compound, preferably a polyether polyol, polyester polyol, polyurethane polyol, polysiloxane polyol, polycarbonate polyol, polyether polyamine, polybutadiene polyol, polyacrylate polyol and/or polymethacrylate polyol or copolymers thereof and particularly preferably a polycarbonate polyol, polyester polyol, polyacrylate polyol or any desired mixtures thereof.

Irrespective of whether it is the coating composition according to the invention or the preferred two-component system according to the invention that is concerned it is further preferable when the at least one isocyanate-reactive binder comprises at least one hydroxy-functional compound having a content of hydroxyl groups of ≥2.0% by weight, preferably of ≥3.0% by weight and particularly preferably of ≥3.5% by weight based on the solids content of the isocyanate-reactive binder.

It is preferable when the ratio of the polyisocyanate mixture according to the invention to isocyanate-reactive compounds in the coating composition according to the invention/the two-component system according to the invention based on the molar amounts of the isocyanate groups relative to the NCO-reactive groups is from 0.8:1.0 to 2.0:1.0. Particular preference is given to a ratio of from 1.0:1.0 to 1.5:1.0. Very particular preference is given to a ratio of from 1.05:1.0 to 1.25:1.0 The polyhydroxyl compounds preferably have mass-average molecular weights Mw >500 daltons, measured by gel permeation chromatography (GPC) against a polystyrene standard, more preferably between 800 and 100 000 daltons, especially between 1000 and 50 000 daltons.

The polyhydroxyl compounds preferably have an OH number of 30 to 400 mg KOH/g, especially between 100 and 300 mg KOH/g. The hydroxyl number (OH number) indicates how many mg of potassium hydroxide are equivalent to the amount of acetic acid bound by 1 g of substance in the acetylation. In the determination, the sample is boiled with acetic anhydride/pyridine, and the acid formed is titrated with potassium hydroxide solution (DIN 53240-2).

The glass transition temperatures, measured with the aid of DSC measurements according to DIN EN ISO 1 1357-2, of the polyhydroxyl compounds are preferably between −150 and 100° C., more preferably between −120° C. and 80° C.

Polyether polyols are obtainable in a manner known per se by alkoxylation of suitable starter molecules under base catalysis or using double metal cyanide compounds (DMC compounds). Examples of suitable starter molecules for producing polyether polyols are simple low molecular weight polyols, water, organic polyamines having at least two N—H bonds, or any mixtures of such starter molecules.

Preferred starter molecules for producing polyether polyols by alkoxylation, in particular by the DMC process, are in particular simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol, and low molecular weight, hydroxyl group-containing esters of such polyols with dicarboxylic acids of the type specified hereinafter by way of example, or low molecular weight ethoxylation or propoxylation products of such simple polyols, or any desired mixtures of such modified or unmodified alcohols. Alkylene oxides suitable for the alkoxylation are especially ethylene oxide and/or propylene oxide which may be employed in the alkoxylation in any desired sequence or else in admixture.

Suitable polyester polyols are described, for example, in EP-A-0 994 1 17 and EP-A-1 273 640. Polyester polyols can be produced in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. It is moreover also possible to polycondense hydroxycarboxylic acid derivatives, for example lactic acid, cinnamic acid or ω-hydroxycaproic acid to form polyester polyols. However, it is also possible to use polyester polyols of oleochemical origin. Such polyester polyols are producible for example by full ring-opening of epoxidized triglycerides of an at least partly olefinically unsaturated fatty acid-containing fat mixture with one or more alcohols having 1 to 12 carbon atoms and subsequent partial transesterification of the triglyceride derivatives to alkyl ester polyols having 1 to 12 carbon atoms in the alkyl radical.

Polyurethane polyols are preferably produced by reaction of polyester polyol prepolymers with suitable di- or polyisocyanates and are described, for example, in EP-A-1 273 640. Suitable polysiloxane polyols are described, for example, in WO-A-01/09260, and the polysiloxane polyols cited therein can preferably be used in combination with further polyhydroxyl compounds, especially those having higher glass transition temperatures.

The polyacrylate polyols that are very particularly preferred in accordance with the invention are generally copolymers and preferably have mass-average molar masses Mw between 1000 and 20 000 daltons, especially between 1500 and 10 000 daltons, measured in each case by means of gel permeation chromatography (GPC) against a polystyrene standard. The glass transition temperature of the copolymers is generally between −100 and 100° C., especially between −50 and 80° C. (measured by means of DSC measurements according to DIN EN ISO 1 1357-2).

The polyacrylate polyols preferably have an OH number of 60 to 250 mg KOH/g, especially between 70 and 200 KOH/g, and an acid number between 0 and 30 mg KOH/g. The acid number here indicates the number of mg of potassium hydroxide which is used for neutralization of 1 g of the respective compound (DIN EN ISO 21 14).

Production of suitable polyacrylate polyols is known per se to those skilled in the art. They are obtained by free-radical polymerization of olefinically unsaturated monomers having hydroxyl groups or by free-radical copolymerization of olefinically unsaturated monomers having hydroxyl groups with optionally other olefinically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate. Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate.

Further monomer structural units used for the polyacrylate polyols may be vinyl aromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

It is alternatively preferable when the binder/component A) of the coating composition according to the invention contains a mixture of at least one polyacrylate polyol and up to 15% by weight, preferably 2 to 12% by weight and particularly preferably 5 to 10% by weight, based on the total amount of polyacrylate polyol, of at least one polyester polyol.

Both the coating composition according to the invention and component A) and/or component B) of the two-component system according to the invention may also contain customary auxiliary and additive substances in effective amounts. Effective amounts for solvents are preferably up to 150% by weight, particularly preferably up to 100% by weight and especially up to 70% by weight, based in each case on the nonvolatile constituents of the two-component system according to the invention/the coating composition according to the invention. Effective amounts of other additives are preferably up to 25% by weight, particularly preferably up to 10% by weight and especially up to 5% by weight, in turn based in each case on the nonvolatile constituents.

Examples of suitable auxiliaries and additions are especially light stabilizers such as UV absorbers and sterically hindered amines (HALS), and also stabilizers, fillers and antisettling agents, defoaming, anticratering and/or wetting agents, leveling agents, film-forming auxiliaries, reactive diluents, solvents, substances for rheology control, slip additives and/or components which prevent soiling and/or improve the cleanability of the cured coatings, and also matting agents.

The use of light stabilizers, especially of UV absorbers, for example substituted benzotriazoles, S-phenyltriazines or oxalanilides, and of sterically hindered amines, especially having 2,2,6,6-tetramethylpiperidyl structures—referred to as HALS—is described by way of example in A. Valet, Lichtschutzmittel für Lacke, Vincentz Verlag, Hanover, 1996.

Stabilizers, for example free-radical scavengers and other polymerization inhibitors such as sterically hindered phenols, stabilize paint components during storage and are intended to prevent discoloration during curing. Also contemplated for component B) are acidic stabilizers such as alkyl-substituted phosphoric partial esters.

The coating composition according to the invention/the two-component system according to the invention may further contain pigments, dyes and/or fillers. The pigments including metallic or other effect pigments, dyes and/or fillers used therefor are known to those skilled in the art.

Preferred fillers are those compounds that have no adverse effect on the appearance of the coating. Examples are nanoparticles based on silicon dioxide, aluminum oxide or zirconium oxide; reference is also made additionally to the Römpp Lexicon “Lacke und Druckfarben” [Coatings and Printing Inks] Georg Thieme Verlag, Stuttgart, 1998, pages 250 to 252.

If fillers, matting agents or pigments are present in the coating composition according to the invention/in the two-component system according to the invention the addition of antisettling agents may be advisable to prevent separation of the constituents in the course of storage.

Wetting and leveling agents improve surface wetting and/or the leveling of coatings. Examples are fluorosurfactants, silicone surfactants, and specific polyacrylates. Rheology control additives are important to control the properties of the coating composition/the two-component system on application and in the leveling phase on the substrate and are known, for example, from patent specifications WO 94/22968, EP-A-0 276 501, EP-A-0 249 201 or WO 97/12945; crosslinked polymeric microparticles are disclosed, for example, in EP-A-0 008 127; inorganic sheet silicates such as aluminum-magnesium silicates, sodium-magnesium and sodium-magnesium-fluorine-lithium sheet silicates of the montmorillonite type; silicas such as Aerosil®; or synthetic polymers having ionic and/or associative groups such as polyvinyl alcohol, poly(meth)acrylamide, poly(meth)acrylic acid, polyvinylpyrrolidone, styrene-maleic anhydride or ethylene-maleic anhydride copolymers and derivatives thereof, or hydrophobically modified ethoxylated urethanes or polyacrylates.

The coating composition according to the invention/the two-component system according to the invention may be employed solventlessly but preferably contains at least one solvent in component A) and/or component B).

Suitable solvents should be used in a manner known to those skilled in the art that is matched to the employed coating composition/the employed two-component system and to the application process. The purpose of solvents is to dissolve the components used and to promote their mixing and also to avoid incompatibilities. In addition, during application and curing, they should escape from the coating in a manner tailored to the crosslinking reaction in progress so as to afford a solvent-free coating of optimal appearance and free of defects such as popping or pinholes. Suitable solvents include in particular those used in two-component technology. Examples are ketones such as acetone, methyl ethyl ketone or hexanone, esters such as ethyl acetate, butyl acetate, methoxypropyl acetate, substituted glycols and other ethers, aromatics such as xylene or solvent naphtha, for example from Exxon-Chemie, and mixtures of the solvents mentioned.

The coating composition according to the invention/the two-component system according to the invention may very readily be used for coating a substrate.

The present invention thus further provides for the use of a polyisocyanate mixture according to the invention or a coating composition according to the invention for producing a coating, preferably a refinishing, on a substrate, wherein the substrate is preferably an optionally pre-treated body, in particular of a vehicle, or parts thereof.

In addition to such a use the invention further provides for a process for producing a coating, preferably a refinish, on a substrate comprising the steps of:
a) providing an optionally pre-treated substrate;
b) applying at least one coating composition according to the invention
c) drying the coating composition at RT or by forced heating at not more than 60° C.

For use in step a) of the aforementioned processes according to the invention the substrates may be uncoated or coated. Coatings may be for example original automotive coatings before these are employed in the process according to the invention. Examples of primers such as those employed in automotive refinishing include solvent-based or aqueous primers, primer-surfacers or filler-surfacers as well as basecoats which are familiar to those skilled in the art for example from A. Goldschmidt, H. Streitberger, “BASF Handbuch Lackiertechnik”, Vincentz-Verlag, Hanover, Germany, 2002. Corresponding products are obtainable for example from BASF Coatings GmbH, Münster, DE under the name “Glasurit” or from Axalta Coatings Systems Germany GmbH, Wuppertal, DE under the name “Spies Hecker Permasolid/Permahyd”.

Suitable substrates are, for example, substrates comprising one or more materials, especially including so-called composite materials. A substrate formed from at least two materials is referred to in accordance with the invention as composite material. Suitable materials are preferably steel, aluminum or galvanized surfaces.

In the context of the invention, the term plastic is also understood to refer to fiber-reinforced plastics, for example glass fiber- or carbon fiber-reinforced plastics, and plastics blends composed of at least two or more plastics.

Examples of plastics suitable in accordance with the invention are ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations according to DIN 7728T1). These may also be in the form of films or in the form of glass fiber- or carbon fiber-reinforced plastics.

In a preferred embodiment of the process according to the invention the substrate has a surface made completely or partially of plastic and/or metal. Particularly preferably, the substrate consists at least partly of a composite material, especially of a composite material comprising plastic and/or metal.

In a further embodiment of the process of the invention, the substrate comprises metal; more particularly, the substrate may consist of metal to an extent of 80% by weight, 70% by weight, 60% by weight, 50% by weight, 25% by weight, 10% by weight, 5% by weight, 1% by weight.

In one embodiment of the invention, the substrate to be provided in step a) is a body or parts thereof which comprise(s) one or more of the aforementioned materials. The body or parts thereof preferably comprise(s) one or more materials selected from metal, plastic, or mixtures thereof.

The application of the coating composition according to the invention/the two-component system according to the invention in step b) of the process according to the invention may be effected from solution. Suitable methods of application are, for example, printing, painting, rolling, casting, dipping, fluidized bed methods and/or spraying, for example compressed air spraying, airless spraying, high rotation, electrostatic spray application (ESTA), optionally combined with hot spray application, for example hot-air spraying. Particularly preferred here is application by spraying such as, for example, compressed air spraying, airless spraying, high-speed rotation, electrostatic spray application (ESTA), optionally in conjunction with hot spray applications such as hot air spraying for example.

The coating composition/the two-component system to be applied in step b) may be applied either after the mixing of components A) and B) or only immediately upon application. In the first case, the mixed two-component system has a limited shelf life, the so-called pot life, since the crosslinking reaction already proceeds slowly after the mixing. In the second case the advantageous effect of the extended pot life is apparent for example in improved paint appearance since the inventive coating composition/the two-component system can form a uniform film on the substrate.

It has been found to be particularly practical for the process according to the invention when the curing in step c) is carried out at a substrate temperature of room temperature to not more than 60° C.

The drying in step c) of the process according to the invention is performed in less than 60 minutes at 60° C., very particularly preferably in less than 30 minutes. Alternatively, a RT drying may be carried out over two or more hours.

Drying, as used here, means that the coating systems have achieved the dust-dry state (T1). Testing according to DIN 53 150:2002-09.

The process of the invention therefore enables the common painting of pure metal substrates and thermoplastics or composite materials. A further advantage of the process according to the invention is that the selected polyisocyanates enable a pot life of more than 30 min in the painting process, exhibit a good gloss retention of the coating of more than 75 units gloss 200 after drying as well as enabling simple manual mixing by manual incorporation with a stirring rod. The simple manual mixing (also referred to here as a good incorporation property) is a further advantage of the polyisocyanate mixture according to the invention. This results in the particularly preferred suitability in the field of manual applications, for example refinishing but also wood lacquering.

The invention further provides a coating produced or producible by the process according to the invention.

The invention further provides a coated substrate, obtainable or produced by the process according to the invention, wherein the optionally pretreated substrate is preferably a body, especially of a vehicle, or parts thereof and/or preferably comprises one or more of the materials selected from metal, plastic or mixtures thereof. On account of the exceptional properties of the polyisocyanate mixture according to the invention/the two-component system according to the invention it is alternatively preferable when the optionally pre-treated substrate is made of wood.

In a preferred embodiment of the invention the substrate coated with the coating composition of the invention may be a body, especially of a vehicle or parts thereof, or a piece of furniture or other workpieces made of wood. The vehicle may be formed from one or more materials. Suitable materials are, for example, metal, plastic or mixtures thereof. The vehicle may be any vehicle known to those skilled in the art. For example, the vehicle may be a motor vehicle, heavy goods vehicle, motorcycle, moped, bicycle or the like. Preferably, the vehicle is a motor vehicle and/or heavy goods vehicle, particularly preferably a motor vehicle.

In a further preferred embodiment of the invention the substrate coated with the coating according to the invention is a body or parts thereof comprising one or more of the materials selected from metal, plastic or mixtures thereof.

The invention will now be more particularly elucidated using examples without being limited to these.

### EXAMPLES

Unless otherwise stated all percentages are based on weight.

NCO contents were determined titrimetrically in accordance with DIN EN ISO 11909:2007-05.

Residual monomer contents were measured in accordance with DIN EN ISO 10283:2007-11 by gas chromatography with an internal standard.

All viscosity measurements were performed with a Physica MCR 51 rheometer from Anton Paar Germany GmbH (DE) in accordance with DIN EN ISO 3219:1994-10 at a shear rate of 250 s⁻¹.

The flow time was determined according to DIN EN ISO 2431:2012-03 using an ISO flow cup with a 4 mm nozzle.

The drying properties of the coating systems were determined according to DIN 53 150:2002-09.

The gloss of the obtained coatings was measured by reflectometry according to DIN EN ISO 2813:1999-06 at a 200 angle.

König pendulum damping was determined according to DIN EN ISO 1522:2007-04 on glass plates. 13C-NMR spectra were recorded using a Bruker AV III HD 600 NMR spectrometer with a Z150361 001 (CP BBO 600SS3 BB-H&F-05 ZE T) sample head. 512 scans were performed with a repetition time (D1) of 4 s and a measurement time (AQ) of 1.57 s.

Molecular weights were measured by gel permeation chromatography according to DIN EN ISO 13885-1:2021-11. This employed four columns (2×PSS SDV 50A, 5μ, 2×PSS SDV 100A, 5μ).

To test the coatings for solvent resistance, small amounts of each of the solvents xylene, 1-methoxypropyl-2-acetate, ethyl acetate and acetone were placed in test tubes and provided with a cottonwool pad at the opening, thus forming a solvent-saturated atmosphere within the test tubes.

The test tubes were then applied to the surface of the paints applied to the glass by the cotton pad and remained there for 1 or 5 minutes. After wiping off the solvent the film was examined for damage/softening/loss of adhesion and rated (0=no change, 5=film completely dissolved). The ratings for the four solvents in each case are reported in the following sequence: xylene, 1-methoxypropyl 2-acetate, ethyl acetate and acetone in the form of four consecutive digits. The test for gasoline resistance was carried out analogously using E10 super gasoline.

### Polyisocyanate 1 (Biuret Polyisocyanate)

Biuret-containing HDI polyisocyanate produced by the process according to EP-B 1158013 (Example 2b) by continuous reaction of 667 parts HDI with 27 parts hexamethylenediamine (HDA) in the presence of one part by weight dibutyl phosphate as catalyst at a temperature of 280° C. Unreacted HDI was removed after the reaction by thin-film distillation at a temperature of 130° C. and a pressure of 0.1 mbar. The obtained polyisocyanate was diluted with butyl acetate to a polyisocyanate content of 75% by weight and had the following characteristics.
NCO content: 16.4%
Monomeric HDI: 0.32%
Viscosity (23° C.): 160 mPas
Allophanate group content: 0 mol %
Isocyanurate group content: ≤5 mol %
Biuret group content: ≥95 mol %
Weight-average molecular weight Mw: 1420 g/mol

### Polyisocyanate 2 (Polyisocyanurate-Polyisocyanate)

HDI polyisocyanate comprising isocyanurate groups, produced by catalytic trimerization of HDI based on Example 11 of EP-A 330 966, with the modification that the catalyst solvent employed was 2-ethylhexanol instead of 2-ethyl-1,3-hexanediol and the reaction was stopped by addition of dibutyl phosphate at an NCO content of the crude mixture of 42.5%. Subsequently, unconverted HDI was removed by thin-film distillation at a temperature of 130° C. and a pressure of 0.2 mbar. The obtained polyisocyanurate-polyisocyanate had the following characteristics.
NCO content: 23.0%
Monomeric HDI: 0.08%
Viscosity (23° C.): 1210 mPas
Allophanate group content: 5 mol %
Isocyanurate group content: 95 mol %
Weight-average molecular weight Mw: 760 g/mol

### Polyisocyanate 3 (Polyisocyanurate-Polyisocyanate)

HDI polyisocyanate comprising isocyanurate groups, produced by catalytic trimerization of HDI based on Example 11 of EP-A 330 966, with the modification that the reaction was stopped by addition of dibutyl phosphate at an NCO content of the crude mixture of 40%. Subsequently, unconverted HDI was removed by thin-film distillation at a temperature of 130° C. and a pressure of 0.2 mbar. The obtained polyisocyanate was diluted with butyl acetate to a polyisocyanate content of 90% by weight and had the following characteristics.
NCO content: 19.6%
Monomeric HDI: 0.08%
Viscosity (23° C.): 500 mPas
Allophanate group content: 8 mol %
Isocyanurate group content: 92 mol %
Weight-average molecular weight Mw: 1120 g/mol

### Polyisocyanate 4 (Polyisocyanurate/Allophanate Polyisocyanate)

100 parts of hexamethylene diisocyanate (HDI) were initially charged and temperature-controlled to 105° C. At this temperature 10 parts of trimethylolpropane were added with stirring. After termination of the urethanation reaction the reaction temperature was reduced to 95° C. The trimerization and allophanatization reaction was then started by adding a 0.5% trimethylbenzylammonium hydroxide solution in 2-ethylhexanol. Once an NCO value of 36% had been achieved the reaction was terminated by adding a stopper solution (10% dibutyl phosphate in HDI) in a weight ratio of 100 parts of catalyst solution to 3 parts of stopper solution. Stirring was continued for a further 30 minutes at 95° C. and the remaining monomeric HDI was then separated off in a short-path evaporator at 140° C. and 0.1 mbar. The obtained polyisocyanate was diluted with butyl acetate to a polyisocyanate content of 80% by weight and had the following characteristics.
NCO content: 15.4%
Monomeric HDI: 0.07%
Viscosity (23° C.): 500 mPas
Allophanate group content: 70 mol %
Isocyanurate group content: 30 mol %
Weight-average molecular weight Mw: 3140 g/mol

### Polyisocyanate Mixture 5 (Inventive)

56 parts of polyisocyanate 2 were diluted with 24 parts of undiluted polyisocyanate 4 and 20 parts of butyl acetate. The resulting polyisocyanate mixture had the following characteristics:
NCO content: 17.6%
Monomeric HDI: 0.06%
Viscosity (23° C.): 128 mPas
Allophanate group content: 28 mol %
Isocyanurate group content: 72 mol %
Weight-average molecular weight Mw: 1520 g/mol

### Polyisocyanate Mixture 6 (Inventive)

32 parts of polyisocyanate 2 were diluted with 48 parts of undiluted polyisocyanate 4 and 20 parts of butyl acetate. The resulting polyisocyanate mixture had the following characteristics:
NCO content: 16.7%
Monomeric HDI: 0.07%
Viscosity (23° C.): 267 mPas
Allophanate group content: 47 mol %
Isocyanurate group content: 53 mol %
Weight-average molecular weight Mw: 2305 g/mol

Examples 1, 2, 3, 4 and 5 (coating compositions and paint testing; inventive and comparative) Varying weight fractions of a commercially available polyester polyol (Desmophen® XP 775; Covestro AG, Leverkusen, DE) having a solids content of 75% by weight and an OH content (based on the delivery form) of 9.5% corresponding to an equivalent weight of 180 g/eq OH were admixed with 0.80 parts by weight of a 50% solution of a commercially available free-radical scavenger (Tinuvin 292, BASF SE) in butyl acetate, 1.20 parts by weight of a 50% solution of a commercially available UV absorber (Tinuvin 384-2, BASF SE) in butyl acetate, 1.20 parts by weight of a 10% solution of a commercially available leveling agent (Byk 331, Byk-Chemie GmbH), 2.50 parts by weight of a 1% solution of dibutyltin dilaurate (DBTL) mixed in butyl acetate and homogeneously mixed by intensive stirring.

Different weights fractions of a solvent mixture consisting of equal weight fractions of butyl acetate, MPA and xylene are then homogeneously incorporated by intensive stirring at room temperature to obtain a non-volatile content of 56% by weight in the coatings to be used.

Varying weight fractions of the polyisocyanates 1, 3, 4 and the polyisocyanate mixtures 5 and 6 also in butyl acetate corresponding to an equivalent ratio of isocyanate groups to hydroxyl groups of 1:1 were then manually incorporated with a stirrer as the crosslinker component.

Coating compositions 1 to 5 were applied to glass plates with the aid of a film drawing frame in each case in a wet film layer thickness of about 150 μm and cured over 30 minutes at 60° C. and aged for 16 hours at 60° C.

Table 1 below shows the compositions of the coating compositions 1 to 5 in parts by weight and table 2 shows the results of the performance tests of the obtained coatings in comparison.

TABLE 1
Comparative examples 1, 2 and 3 and inventive examples
4 and 5 - composition of coating compositions

| | 1 | 2 | 3 | 4 | 5 |
|---|---|---|---|---|---|
| Example | (Comparative) | (Comparative) | (Comparative) | (inv.) | (inv.) |
| Desmophen XP 775 (75% in BA) | 45.60 | 45.40 | 42.10 | 45.60 | 43.80 |
| Tinuvin 292 (50% in BA) | 0.80 | 0.80 | 0.80 | 0.80 | 0.80 |
| Tinuvin 384-2 (50% in BA) | 1.20 | 1.20 | 1.20 | 1.20 | 1.20 |
| Byk 331 (10% in BA) | 1.20 | 1.20 | 1.20 | 1.20 | 1.20 |
| DBTL (1% in BA) | 2.50 | 2.50 | 2.50 | 2.50 | 2.50 |
| BA:MPA:xylene = 1:1:1 | 34.10 | 44.90 | 38.30 | 38.10 | 38.20 |
| Polyisocyanate 1 (75% in BA) | 64.60 | — | — | — | — |
| Polyisocyanate 3 (90% in BA) | — | 54.00 | — | — | — |
| Polyisocyanate 4 (80% in BA) | — | — | 63.80 | — | — |
| Polyisocyanate mixture | — | — | — | 60.50 | — |
| 5 (80% in BA) | | | | | |
| Polyisocyanate mixture | — | — | — | — | 62.20 |
| 6 (80% in BA) | | | | | |
| Flow time DIN 4 mm [s] | 19 | 16 | 18 | 16 | 16 |
| 30 minutes after crosslinking | 39 | 21 | 38 | 21 | 22 |
| 60 min. after crosslinking | gelled | 91 | gelled | 115 | 118 |

TABLE 2
Comparative examples 1, 2 and 3 and inventive examples 4 and 5 - Paint properties

| | | 1 | 2 | 3 | 4 | 5 |
|---|---|---|---|---|---|---|
| Example | | (Comparative) | (Comparative) | (Comparative) | (inv.) | (inv.) |
| Layer thickness [μm] | | about 40 | about 40 | about 40 | about 40 | about 40 |
| Gloss 20° | | 89 | 41 | 87 | 78 | 84 |
| Solvent resistance 30 | 1 min | 0002 | 0002 | 0000 | 0001 | 0001 |
| min/60° C. + 16 h/60° C. | | | | | | |
| (X, MPA, EA, A) | | | | | | |
| Solvent resistance 30 | 5 min | 0002 | 0024 | 0001 | 0002 | 0002 |
| min/60° C. + 16 h/60° C. | | | | | | |
| (X, MPA, EA, A) | | | | | | |

As is apparent from table 2, the biuret-based and allophanate-based isocyanate systems (comparative examples 1 and 3) do achieve a high gloss and a good solvent resistance but do not have an adequate pot life since the viscosity increases significantly after just 30 min. Conversely, an isocyanurate-based system (comparative example 2) does achieve a good processing time but only inadequate gloss.

Chemicals resistance also does not quite match the high level of the comparative systems, especially toward acetone as test substance.

Only the polyisocyanate mixtures according to the invention lead to High Solids paint systems (non-volatile fraction upon use >56% by weight) which exhibit high chemicals resistance coupled with a long pot life and a good appearance.

1. A polyisocyanate mixture comprising at least one polyisocyanurate-polyisocyanate and at least one polyallophanate-polyisocyanate, wherein the polyisocyanate mixture has:
a content of monomeric diisocyanates of <0.10% by weight determined by gas chromatography with an internal standard according to DIN EN ISO 10283:2007-11,
an isocyanurate group content of ≥40 mol % to ≤85 mol % determined by NMR spectroscopic analysis and based on the total amount of isocyanurate groups and allophanate groups of the polyisocyanate mixture and
an allophanate group content of ≥15 mol % to ≤60 mol % determined by NMR spectroscopic analysis and based on the total amount of isocyanurate groups and allophanate groups of the polyisocyanate mixture.

2. The polyisocyanate mixture of claim 1,
wherein the isocyanurate group content is ≥45 mol-% to ≤80 mol-%, determined by NMR spectroscopic analysis and based on the total amount of isocyanurate groups and allophanate groups of the polyisocyanate mixture, and
wherein the allophanate group fraction of ≥20 mol % to ≤55 mol %, determined by NMR spectroscopic analysis and based on the total amount of isocyanurate groups and allophanate groups of the polyisocyanate mixture.

3. The polyisocyanate mixture of claim 1, having a weight-average molecular weight of ≥1000 g/mol to ≤3000 g/mol, determined according to DIN EN ISO 13885-1:2021-11.

4. The polyisocyanate mixture of claim 1, having a polydispersity of ≥1.5 to ≤2.5, determined according to DIN 55672-1:2016-03.

5. The polyisocyanate mixture of claim 1, wherein the at least one polyallophanate-polyisocyanate is obtained by oligomerization of at least one aliphatic, cycloaliphatic or araliphatic monomeric diisocyanate having a molecular weight of ≥140 to ≤400 g/mol and at least one hydroxy-functional compound having an OH functionality of ≥3 and ≤6.

6. The polyisocyanate mixture of claim 1, wherein the at least one polyisocyanurate-polyisocyanate comprises one or more isocyanurate groups which are each chemically bonded to one another via an aliphatic, cycloaliphatic or araliphatic group having a molecular weight of ≥56 to ≤316 g/mol.

7. The polyisocyanate mixture of claim 1, wherein the at least one polyallophanate-polyisocyanate comprises one or more allophanate groups which are each chemically bonded to one another via an aliphatic, cycloaliphatic or araliphatic group having a molecular weight of ≥56 to ≤316 g/mol, preferably each chemically bonded to one another via a 1,4-butyl or 1,6-hexyl group and particularly preferably each chemically bonded to one another via a 1,6-hexyl group.

8-10. (canceled)

11. A coating composition comprising at least one isocyanate-reactive binder in a component A) and the at least one polyisocyanate mixture of claim 1 in a component B), wherein the at least one isocyanate-reactive binder is a polyester polyol, a polyacrylate polyol or mixture thereof.

12. The coating composition of claim 11, wherein the at least one isocyanate-reactive binder comprises at least one hydroxy-functional compound having a content of hydroxyl groups of ≥2.0% by weight, based on the solids content of the isocyanate-reactive binder.

13. (canceled)

14. A process for producing a coating on a substrate, comprising the steps of:
a) providing an optionally pre-treated substrate;
b) applying at least one coating composition of claim 11;
c) curing the coating composition by heating.

15. (canceled)

16. The coating composition of claim 11, wherein the at least one isocyanate-reactive binder comprises at least one hydroxy-functional compound having a content of hydroxyl groups of ≥3.5% by weight based on the solids content of the isocyanate-reactive binder.

17. The polyisocyanate mixture of claim 1, wherein the isocyanurate group content is ≥50 mol-% to ≤75 mol-%, determined by NMR spectroscopic analysis and based on the total amount of isocyanurate groups and allophanate groups of the polyisocyanate mixture, and
wherein the allophanate group fraction of ≥25 mol % to ≤50 mol %, determined by NMR spectroscopic analysis and based on the total amount of isocyanurate groups and allophanate groups of the polyisocyanate mixture.

18. The polyisocyanate mixture of claim 1, wherein the isocyanurate group content is ≥53 mol % to ≤72 mol %, determined by NMR spectroscopic analysis and based on the total amount of isocyanurate groups and allophanate groups of the polyisocyanate mixture, and
wherein the allophanate group fraction of ≥28 mol % to ≤47 mol %, determined by NMR spectroscopic analysis and based on the total amount of isocyanurate groups and allophanate groups of the polyisocyanate mixture.

19. The polyisocyanate mixture of claim 1, having a weight-average molecular weight of ≥1300 g/mol to ≤2700 g/mol, determined according to DIN EN ISO 13885-1:2021-11.

20. The polyisocyanate mixture of claim 1, having a weight-average molecular weight of ≥1500 g/mol to ≤2500 g/mol, determined according to DIN EN ISO 13885-1:2021-11.

21. The polyisocyanate mixture of claim 1, having a polydispersity of ≥1.7 to ≤2.2, determined according to DIN 55672-1:2016-03.

22. The polyisocyanate mixture of claim 1, wherein the at least one polyisocyanurate-polyisocyanate comprises one or more isocyanurate groups which are each chemically bonded to one another via an aliphatic, cycloaliphatic or araliphatic group, each chemically bonded to one another via a 1,4-butyl or 1,6-hexyl group.

23. The polyisocyanate mixture of claim 1, wherein the at least one polyisocyanurate-polyisocyanate comprises one or more isocyanurate groups which are each chemically bonded to one another via an aliphatic, cycloaliphatic or araliphatic group, each chemically bonded to one another via a 1,6-hexyl group.

24. The polyisocyanate mixture of claim 1, wherein the at least one polyallophanate-polyisocyanate comprises one or more allophanate groups which are each chemically bonded to one another via an aliphatic, cycloaliphatic or araliphatic group, each chemically bonded to one another via a 1,4-butyl or 1,6-hexyl group.

25. The polyisocyanate mixture of claim 1, wherein the at least one polyallophanate-polyisocyanate comprises one or more allophanate groups which are each chemically bonded to one another via an aliphatic, cycloaliphatic or araliphatic group, each chemically bonded to one another via a 1,6-hexyl group.
